(19) United States
(12) Patent Application Publication
(10) Pub. No.: US 2008/0038015 A1
(43) Pub. Date: Feb. 14, 2008

(54) Apparatus and method for shifting an image-forming region of a printing device

(75) Inventors: Cheng-Yi Lai, Hsinchu (TW); Yen-Liang Meng, Hsinchu (TW); Ming-Hsiung Wang, Hsinchu (TW); Hung-Ming Hsu, Hsinchu (TW)

Correspondence Address: RABIN & Berdo, PC, 1101 14TH STREET, NW, SUITE 500, WASHINGTON, DC, 20005, US

(73) Assignee: AETAS TECHNOLOGY, INCORPORATED, Irvine, CA (US)

(21) Appl. No.: 11/500,399

(22) Filed: Aug. 8, 2006

(51) Int. Cl. G03G 15/00

(52) U.S. Cl. 399/160

(57) ABSTRACT

An apparatus and method for shifting the image-forming region of a printing device is disclosed. The apparatus includes a photoconductor, an encoder, several rollers, and a controlled device. The present invention is used to shift the image-forming region in the photoconductor by the controlled device. The damage of the image-forming region in the photoconductor can be reduced. The lifetime of the photoconductor can be extended. In addition, the controlled device uses firmware to shift the image-forming region. The shifting method can be a sequential mode or random mode.

### BACKGROUND

1. Field of Invention

The present invention relates to an apparatus and method for shifting an image-forming region of a printing device. More particularly, the present invention relates to an apparatus and method for shifting an image-forming region on a photosensitive medium of a printer, which is able to extend the lifetime of the photosensitive medium.

2. Description of Related Art

An electrophotographic image forming apparatus use Electrophotography (EPG) imaging process to print images. EPG imaging process comprises several steps: charging, exposure, developing, transferring, and fusing. The electrophotographic imaging process is typically achieved by the following process. In the charging step, a charging element applies a charging voltage to the surface of a photosensitive medium (i.e. photoreceptor). In the exposure step, an optical writing device (irradiated using a light-emitting diode or a laser) to form a latent image on a charged surface of the photoreceptor charged by the charging element. The developing step starts right after the required latent image is formed on the photoreceptor. A developer member to carry toner having a same polarity as that of the charging voltage to the photoreceptor and which applies the toner to the latent image on the photoreceptor to form a toner image.

Once the developing step is finished, the transferring step transfers the toner image formed on the photoreceptor to paper. Finally, in the fusing step, the toners are fixed on the paper with a heat roller and a pressure roller.

The common photoconductor is an Organic Photoconductor (OPC). If the images are developed in the same region of the OPC all the time, the region is easily to form a scum pattern because of the friction of the external force, such as the printing paper or a cleaning knife. Therefore, the efficiency of the cleaning knife to clean the OPC is decreased and the lifetime of the OPC is shortened.

### SUMMARY

The main object of the present invention is to provide a method to shift an image-forming region of a printing device. The method is used to decrease the use of the same fixed region in the photoconductor when printing some images and extend the lifetime of the photoconductor.

Another object of the present invention is to provide an apparatus to shift the image-forming region of a printing device. The apparatus can be used to decrease the use of the same region to print images in the photoconductor and extend the lifetime of the photoconductor.

The other object of the present invention is to provide an apparatus and method to shift an image-forming region of a printing device. The apparatus and method delays the scum pattern formation time and reduces the cost of the printing device.

The present invention is an improved method for printing an image. The printing device shifts the initial position of the image-forming region to a distance when printing some images. As all the components in the printing device have been started, the images can be exposed and printed in the printing device. By the method of the present invention, the damage to the same fixed region of the photoconductor can be reduced and the scum pattern formation time can be delayed. Therefore, the lifetime of the photoconductor can be extended.

According to the objectives described above, the method to shift an image-forming region of a printing device includes the following steps: detecting the initial position of a printable region in the printing device; computing the shifting distance with the firmware of a controlled device; calculating the initial position of the image-forming region, wherein the initial position of the image-forming region is equal to the initial position of the printable region plus the shifting distance; and positioning the printing device in the initial position of the printable region.

An apparatus for shifting an image-forming region of a printing device includes a photoconductor, which includes at least one encoding strip in one of two sides of the photoconductor; at least one roller used to roll the photoconductor; a controlled device driving the roller and including firmware, which can calculate the shifting distance and move the initial position of the image-forming region to the shifting distance; and an encoder detecting a plurality of encoding strip bar codes.

### BRIEF DESCRIPTION OF THE DRAWINGS

The invention can be more fully understood by reading the following detailed description of the preferred embodiment, with reference made to the accompanying drawings as follows:

FIG. 1 is a flowchart of a method for shifting an image-forming region of a printing device.

FIG. 2A-FIG. 2F are plan views of a method for shifting an image-forming region of a printing device in sequential mode.

FIG. 3 is a side view of an apparatus for shifting an image-forming region of a printing device.

### DESCRIPTION OF THE PREFERRED EMBODIMENTS

Reference will now be made in detail to the present preferred 10 embodiments of the invention, examples of which are illustrated in the accompanying drawings. Wherever possible, the same reference numbers are used in the drawings and the description to refer to the same or like parts.

The apparatus and method for shifting an image-forming region of a photoconductor is used in a printing device, such as an Electrophotography (EPG) printing device. When the printing device is prompted to do an Electrophotographic print, it passes an initial position of a printable region on the photoconductor and the Electrophotographic print can be started after passing the initial position of the printable region. A plurality of Electrophotographic steps (such as charging, exposure, developing, transfer and fusing) use the initial position of the printable region as the reference to do the specific step after moving to an established distance. The printing device includes a photoconductor with a code strip mounted thereon and an encoder, which is used to detect the code strip and position the location of the photoconductor. The code strip includes a plurality of bar codes and is used to let the printing device know when to start the exposure device or the developing device.

According to the apparatus and method for shifting the image-forming region of the printing device, the image-forming region of the photoconductor can be shifted to a distance using a controlled device of the printing device. By shifting the image-forming region to a specified distance, it can prevent the repeated use of the same region to form the image, and reduce the friction of the same region in the photoconductor. Therefore, the scum pattern formation time can be delayed and the lifetime of the photoconductor extended. The spirit of the present invention can be described in detail by the following description with drawings.

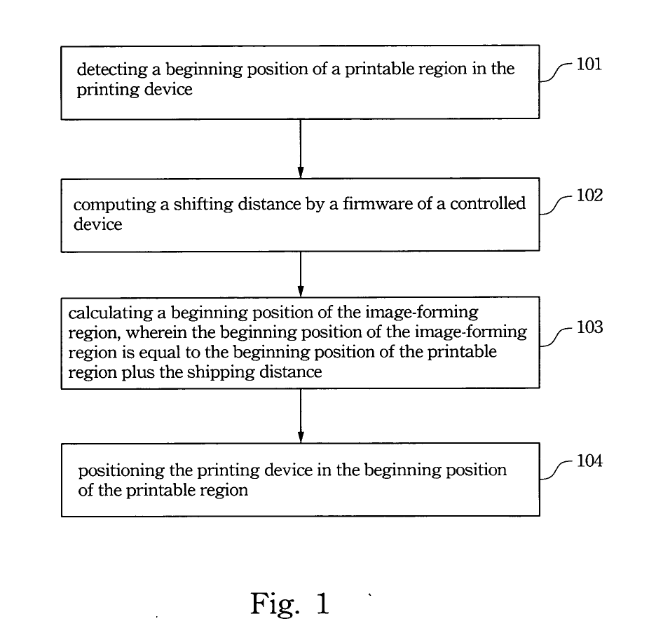

Refer to FIG. 1 it is a flowchart showing the shifting method for shifting the image-forming region of the printing device. The shifting method used for shifting the image-forming region of the printing device includes the following steps: Step 101: an initial position of a printable region in the printing device is detected by encoder using a plurality of bar codes of code strip on the photoconductor. The initial position of the printable region is a reference position. All the movements to print an image in the printing device are made with respect to the reference position. Step 102: the shifting distance is computed with the controlled device firmware. Step 103: the initial position of the image-forming region is calculated, and the initial position of the image-forming region is equal to the initial position of the printable region plus the shifting distance. Step 104: the printing device is positioned in the initial position of the printable region. Moreover, the firmware of the controlled device uses a look-up table to let the controlled device drive the roller (which is used to roll the photoconductor) and shift the initial position of the printable region of the printing device to the specific position to perform the established operation. The shifting distance can be generated with either a sequential mode or a random mode. In addition, the photoconductor is an organic photoconductor (OPC) and the OPC is an Organic Photoconductor Belt or an Organic Photoconductor Drum.

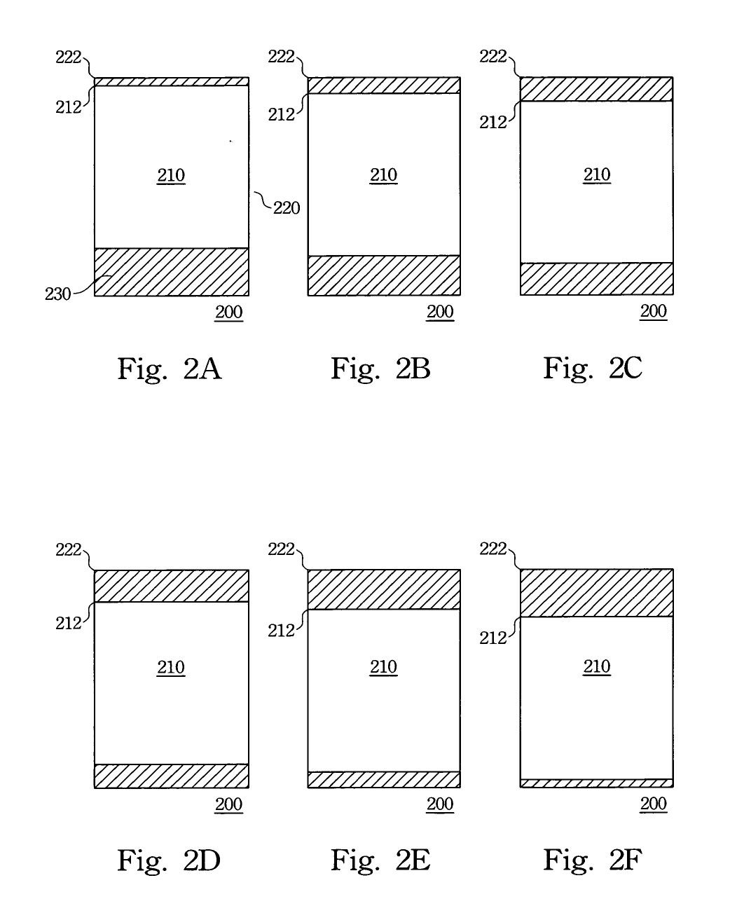

Refer to FIG. 2A to FIG. 2F are views of the method for shifting the image-forming region 210 of the photoconductor 200 in a sequential mode. Refer to FIG. 2A shows the photoconductor 200 includes a printable region 220 and a non-printable region (not shown) and the image-forming region 210 is formed inside the printable region 220. According to the method for shifting the image-forming region on the photoconductor 200 of the printing device, when printing the first image, the initial position 222 of the printable region 220 is used as a reference position. The method of the present invention is to shift the photoconductor 200 to a distance and the position of the photoconductor 200 to the initial position 212 of the image-forming region 210. The first image is printed from the initial position 212 of the image-forming region 210. However, after printing the first image, there is a region 230 (such as the shadow region in FIG. 2A) below the image-forming region 210. If the conventional printing method is used, the region 230 below the image-forming region 210 won't be used when printing images. The images are always printed from the initial position 222 of the image-forming region 220. When the images are in transferring, those transferring components, such as papers, are hitting the photoconductor 200 in the same position. The photoconductor 200 is easy to be damaged and the scum pattern is formed. Therefore, the lifetime of the photoconductor are decreased.

The embodiment of the present invention are shown in FIG. 2B. According to the method for shifting the image-forming region of the printing device, the photoconductor 200 is shifted to a new distance according to the referential position of the initial position 222 of the printable region 220. The initial position 212 of the image-forming region 210 in FIG. 2A is different to the initial position 212 of the image-forming region 210 in FIG. 2B. The second image is printed from the initial position 212 of the image-forming region 210 in FIG. 2B. As shown in FIG. 2C, FIG. 2D and FIG. 2E, the image-forming region 210 is sequentially shifted to a specified distance. The number of times an image is formed in the same region is reduced and the damage to the image-forming region 210 decreased. Finally, as shown in FIG. 2F, the image-forming region 210 of the Nth image will be near the bottom of the printable region 220. After printing the Nth image, the initial position 212 of the image-forming region 210 of the N+1th image is the same as the initial position 212 of the image-forming region 210 of the first image in FIG. 2A and the N+1th image is printed in the image-forming region 210 in FIG. 2A. However, FIG. 2A to FIG. 2E are drawings of one embodiment to describe the method for shifting the image-forming region of the printing device. The number of times to shift the image-forming region in the printing device and the length of the shifting distance can be adjusted according to the length of the image-forming region. For example, in the embodiment of the present invention, the shifting distance is 1 mm. The number of times to shift the distance can be adjusted and is not limited in the present invention.

On the other hand, the method for shifting the image-forming region of the printing device in a random mode is similar to the sequential mode. The different between the random mode and the sequential mode is the selection of the initial position of the image-forming region. The sequential mode shifts the image-forming region to a distance in order and the random mode shifts the image-forming region to a distance randomly. The way to randomly shift the image-forming region to a distance does require the arrangement shown in FIG. 2A to FIG. 2E. In the random mode, the scum pattern formation time is delayed and the lifetime of the photoconductor can also be extended.

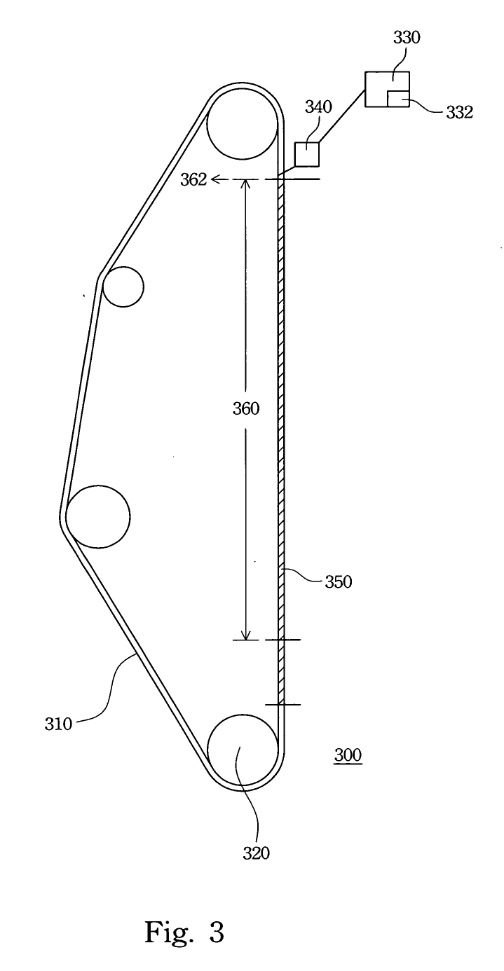

Refer to FIG. 3 is a side view of the apparatus for shifting the image-forming region of the printing device. The shifting apparatus 300 includes a photoconductor 310, at least one roller 320, a controlled device 330, and an encoder 340. The photoconductor 310 includes a code strip 350, which is disposed in the side of the photoconductor 310 and includes a plurality of bar codes (not shown). The photoconductor 310 illustrated herein in the form of an endless belt stretched across the rollers 320 can be moved by the roller 320. The printing device proceeds with the specific step in the specific location by the encoder 340 detecting the bar codes of the code strip 350. The controlled device 330 includes firmware 332, which utilizes a look-up table to drive the rollers 320. The rollers 320 move the photoconductor 310 to a specific location to do an established job. The firmware 332 computes a shifting distance according to the look-up table and the controlled device 330 shifts the image-forming region 360 to a specified distance. The key point of the present invention is to identify the initial position of the image-forming region in the firmware. The firmware uses a constant to identify the initial position of the image-forming region in the conventional printing device. The printing device returns to the same initial position of the image-forming region to do the other image printing after printing one page. However, the firmware uses a variable to identify the initial position of the image-forming region in the present invention. The printing device won't return to the same initial position of the image-forming region after printing one page. Therefore, the damage caused by using the same region can be reduced. Moreover, the variable can be sequentially or randomly generated. The photoconductor is an organic photoconductor and can be an organic photoconductor belt or an organic photoconductor drum.

According to the description of the preferred embodiment, the present invention includes the following advantages:

(1) The time to scum pattern formation pattern is be delayed and the lifetime of the photoconductor extended by shifting the image-forming region of the printing device.

(2) There are no any extra mechanical components added to the present invention and no changes the design of the mechanical structure of the printing device. The purpose of the present invention is to shift the image-forming region.

(3) The design of the controlled device firmware does not necessarily have to be substantially changed and the computing method of the initial position of the image-forming region is simple.

Although the present invention has been described in considerable detail with reference certain preferred embodiments thereof, other embodiments are possible. Therefore, their spirit and scope of the appended claims should no be limited to the description of the preferred embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for shifting an image-forming region of a printing device, comprising:
detecting an initial position of a printable region of a photoconductor in the printing device;
computing a shifting distance by a controlled device firmware;
calculating an initial position of the image-forming region, wherein the initial position of the image-forming region is equal to the initial position of the printable region plus the shifting distance; and
positioning the printing device in the initial position of the image-forming region and beginning to form image.

2. The method of claim 1, wherein the firmware comprises a look-up table and the shifting distance can be computed by adjusting the look-up table.

3. The method of claim 1, wherein the method is in a sequential mode to shift the image-forming region.

4. The method of claim 1, wherein the method is in a random mode to shift the image-forming region.

5. The method of claim 1, wherein the method is used in an Electrophotographic (EPG) printing device.

6. The method of claim 1, wherein the photoconductor is an Organic Photoconductor (OPC).

7. The method of claim 1, wherein the photoconductor is an Organic Photoconductor belt.

8. The method of claim 1, wherein the photoconductor is an Organic Photoconductor drum.

9. The method of claim 1, wherein the image shifting distance is at least 1 mm.

10. An apparatus for shifting an image-forming region of a printing device, comprising:
a photoconductor including at least one code strip, which is disposed on one side of the photoconductor, and the code strip having a plurality of bar codes,
at least one roller used to roll the photoconductor;
a controlled device driving the roller and including a firmware, which can calculate a shifting distance and move a initial position of the image-forming region to the shifting distance; and
an encoder detecting the plurality of bar codes.

11. The method of claim 10, wherein the firmware comprises a look-up table and the shifting distance can be computed by adjusting the look-up table.

12. The apparatus of claim 10, wherein the firmware uses a variable to identify the shifting distance of the image-forming region.

13. The apparatus of claim 12, wherein the variable is randomly generated.

14. The apparatus of claim 12, wherein the variable is sequentially generated.

15. The apparatus of claim 12, wherein the apparatus is used in an Electrophotographic (EPG) printing device.

16. The apparatus of claim 10, wherein the photoconductor is an Organic Photoconductor (OPC).

17. The method of claim 10, wherein the photoconductor is an OPC belt.

18. The method of claim 10, wherein the photoconductor is an OPC drum.

19. The method of claim 10, wherein the image shifting distance is at least 1 mm.

20. A method for shifting an image-forming region of an electrophotographic image forming apparatus, wherein the apparatus includes a photoconductor and an electrostatic latent image formed on the photoconductor, and the method comprises:
detecting an initial position of a printable region in the photoconductor by an encoder; and
outputting a shifting signal and shifting the electrostatic latent image from the initial position of the printable region to a distance and forming the image.
